(19) United States
(12) Patent Application Publication
(10) Pub. No.: US 2026/0212680 A1
(43) Pub. Date: Jul. 23, 2026

(54) IN-VEHICLE PROCESSING DEVICE AND OBJECT RECOGNITION METHOD

(71) Applicant: Astemo, Ltd., Tokyo (JP)

(72) Inventors: Go SAKAYORI, Tokyo (JP); Hideaki KIDO, Tokyo (JP); Hidehiro TOYODA, Ibaraki (JP)

(21) Appl. No.: 19/140,663

(22) PCT Filed: Nov. 7, 2023
(86) PCT No.: PCT/JP2023/039995

§ 371 Date: Jun. 18, 2025

(30) Foreign Application Priority Data
Dec. 28, 2022 (JP) 2022-212077

(51) Int. Cl. G06V 20/58; G06V 10/25; G06V 10/74; G06V 10/75

(52) U.S. Cl. CPC G06V 20/58; G06V 10/25; G06V 10/757; G06V 10/759; G06V 10/761; G06V 2201/08

(57) ABSTRACT

An aspect of the present invention includes: a point group storage unit that stores a first point group acquired by measuring a first external region; a point group missing region estimation unit that estimates a point group missing region that is a region where measurement points included in a point group acquired in an object around a vehicle do not satisfy a predetermined condition; a point group matching unit that matches the stored first point group with a second point group acquired by measuring a second external region, in the point group missing region; a third point group generation unit that generates a third point group using the first point group and the second point group matched by the point group matching unit; and an object recognition unit that recognizes the object using the third point group.

### TECHNICAL FIELD

The present invention relates to an in-vehicle processing device and an object recognition method for enabling an autonomous driving vehicle to act in cooperation with another vehicle or the like.

### BACKGROUND ART

In order to optimally control the autonomous driving vehicle in an environment in which a plurality of movable objects is mixed, it is necessary to correctly recognize surrounding environment and to understand an action intention of a peripheral movable object. In general, the autonomous driving vehicle recognizes the surrounding environment using image information acquired from an external sensor and information (point group information) of a plurality of measurement points. As techniques related to surrounding environment recognition using the point group information, there are inventions described in PTL 1 and PTL 2.

The invention described in PTL 1 clusters first point group data acquired by a sensor to generate a first cluster point group. Then, in the invention described in PTL 1, each of first clusters included in the first cluster point group is fused to each of point group clusters acquired earlier than the first point group data to update a cluster group and recognize the surrounding environment.

The invention described in PTL 2 relates to a data processing device that projects three-dimensional point group data onto a two-dimensional grid to generate a road surface image, and estimates a deformation amount indicating a relative positional relationship among a plurality of road surface images. At this time, a self-position is estimated and the surrounding environment is recognized by adjusting a positional deviation between a plurality of pieces of three-dimensional point group data while suppressing an amount of calculation.

### CITATION LIST

### Patent Literature

PTL 1: WO 2022/009602 A

PTL 2: JP 2018-169825 A

### SUMMARY OF INVENTION

### Technical Problem

However, in the invention described in PTL 1, although an amount of information is reduced by clustering the acquired point group information, a new point group cluster is fused with a point group cluster acquired earlier. By sequentially fusing the point group clusters rather than as needed, the amount of information possessed by a host moving body increases, and calculation time required for recognizing the surrounding environment may increase.

In the invention described in PTL 2, the amount of information is reduced by projecting the three-dimensional point group data onto the two-dimensional grid. In reduction of the amount of information described in PTL 2, since a recognition target object is road surface paint information, it is considered that problems are not apparent.

Incidentally, in order to grasp the action intention of the movable object around the autonomous driving vehicle, it is necessary to determine a type of the movable object. In the invention described in PTL 2, one-dimensional reduction of the point group information makes it difficult to classify a type of a target movable object as compared with that before the reduction.

In addition, it is desirable that the point group information is dense in order to perform advanced type separation, but it is considered that the surrounding environment cannot be recognized with high accuracy in a case where the point group information is missing.

In view of the above situation, an object of the present invention is to enable recognition of at least an object around the autonomous driving vehicle with high accuracy also when there is a missing region of a point group in the point group information of the object acquired from the external sensor in order to enable the autonomous driving vehicle to act in cooperation with the object around the autonomous driving vehicle.

### Solution to Problem

In order to solve the above problem, an in-vehicle processing device according to an aspect of the present invention includes: a first point group acquisition unit that acquires a first point group measured in a first external region by an external sensor mounted on a vehicle; a second point group acquisition unit that acquires a second point group measured in a second external region including a region different from the first external region by the external sensor or an external sensor different from the external sensor; and a point group processing unit that processes the first point group and the second point group. The point group processing unit includes: a point group storage unit that stores the first point group; a point group missing region estimation unit that estimates a point group missing region that is a region where measurement points included in a point group acquired in an object around the vehicle do not satisfy a predetermined condition; a point group matching unit that matches the stored first point group with the second point group acquired by the second point group acquisition unit, in the point group missing region; a third point group generation unit that generates a third point group using the first point group and the second point group matched by the point group matching unit; and an object recognition unit that recognizes the object using the third point group.

### Advantageous Effects of Invention

According to at least one aspect of the present invention, it is possible to recognize at least the object around the vehicle with high accuracy also when there is the missing region of the point group in the point group information of the object acquired from the external sensor. Problems, configurations, and effects other than those described above will be clarified by the following description of embodiments.

### BRIEF DESCRIPTION OF DRAWINGS

FIG. 1 is a schematic diagram illustrating a configuration example of an autonomous driving vehicle including an in-vehicle processing device according to a first embodiment of the present invention.

FIG. 2 is a diagram illustrating a configuration example of the in-vehicle processing device according to the first embodiment of the present invention.

FIG. 3 is a flowchart illustrating a procedure example of object recognition processing of the in-vehicle processing device according to the first embodiment of the present invention.

FIG. 4 is a diagram illustrating an example of an environment in which the autonomous driving vehicle and an oncoming vehicle pass each other.

FIG. 5 is a diagram illustrating an example of a detectable region of an external sensor mounted on the autonomous driving vehicle in the first embodiment of the present invention.

FIG. 6 is a diagram illustrating an example of a sensing result of the external sensor at the time of an initial action in a passing-each-other action of the autonomous driving vehicle in the first embodiment of the present invention.

FIG. 7 is a diagram illustrating an example of the sensing result of the external sensor when the autonomous driving vehicle moves to an evacuation path to perform the passing-each-other action with the oncoming vehicle in the first embodiment of the present invention.

FIG. 8 is a diagram illustrating an example of the sensing result of the external sensor in a case where a lateral distance between the autonomous driving vehicle and the oncoming vehicle is extremely short in the first embodiment of the present invention.

FIG. 9 is a diagram illustrating an example of matching between a second acquired point group and a stored point group in the first embodiment of the present invention.

FIG. 10 is a diagram illustrating another example of the matching between the second acquired point group and the stored point group in the first embodiment of the present invention.

FIG. 11 is a diagram illustrating an example in which the oncoming vehicle moves backward in the first embodiment of the present invention.

FIG. 12 is a diagram illustrating an example when the autonomous driving vehicle has entered an intersection in a second embodiment of the present invention.

FIG. 13 is a diagram illustrating an example when a pedestrian is crossing a road at the intersection where the autonomous driving vehicle has entered in the second embodiment of the present invention.

FIG. 14 is a diagram illustrating a configuration example of the in-vehicle processing device according to a third embodiment of the present invention.

FIG. 15 is a flowchart illustrating a procedure example of the object recognition processing of the in-vehicle processing device according to a third embodiment of the present invention.

FIG. 16 is a diagram illustrating an example of an environment in which the autonomous driving vehicle merges in cooperation with a plurality of surrounding vehicles traveling on a main lane of a freeway in the third embodiment of the present invention.

FIG. 17 is a diagram illustrating an example of an operation in which the autonomous driving vehicle communicates with a roadside external sensor and stores a dense point group of the surrounding vehicles traveling on the main lane in the third embodiment of the present invention.

### DESCRIPTION OF EMBODIMENTS

Hereinafter, examples of modes (hereinafter referred to as “embodiments”) for carrying out the present invention will be described with reference to the accompanying drawings. In the present specification and the accompanying drawings, the same components or components having substantially the same function are denoted by the same reference numerals, and redundant description is omitted.

### First Embodiment

### [Configuration of Autonomous Driving Vehicle Equipped With In-vehicle Processing Device]

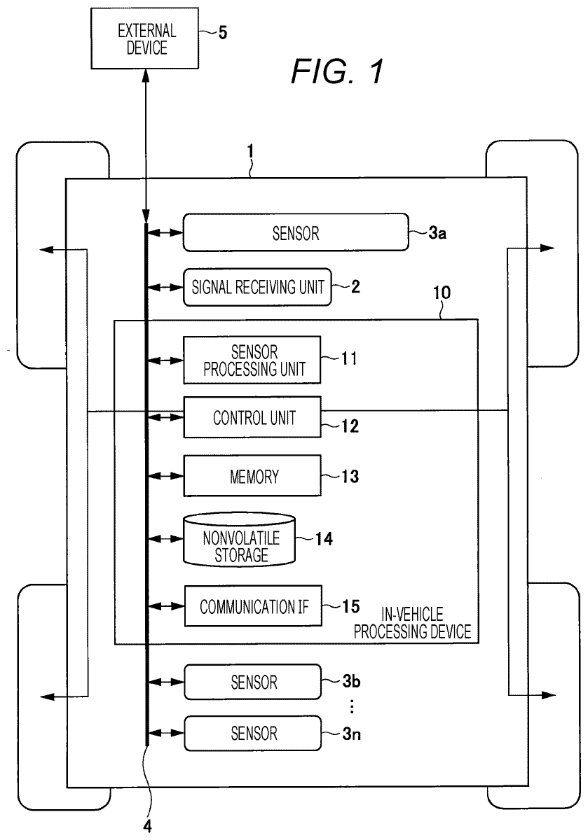

FIG. 1 is a schematic diagram illustrating a configuration example of an autonomous driving vehicle including an in-vehicle processing device according to a first embodiment of the present invention. In FIG. 1, an autonomous driving vehicle 1 includes a signal receiving unit 2, one or more sensors 3a, 3b, - - - , and 3n, and an in-vehicle processing device 10. These components are connected to each other by a bus 4. In the present specification, the sensors 3a, 3b, - - - , and 3n are referred to as a sensor 3 unless otherwise distinguished.

The sensor 3 is a sensor attached to the autonomous driving vehicle 1. The sensor 3 includes two or more external sensors capable of acquiring a point group. Measurement points included in the point group represent coordinates in a space located on a surface or inside of an object having a shape. It is possible to detect information on the shape of the object around a host vehicle and information on a distance to the object on the basis of point group information acquired by the external sensors. Measurement point data may include information on luminance and color.

As the sensor 3, a stereo camera, a laser radar, a millimeter wave radar, an ultrasonic sensor, or the like can be used. For example, one (a first external sensor) of the external sensors is installed in front of the autonomous driving vehicle 1. In the present embodiment, the first external sensor has a lens, and acquires information (an example of first region information) on a front region of the autonomous driving vehicle 1. In addition, another external sensor (a second external sensor) is installed on a side of the autonomous driving vehicle 1 and acquires information (an example of second region information) on a side region of the autonomous driving vehicle 1.

The sensors 3a to 3n acquire information when receiving an information acquisition start (a measurement start) command from a control unit 12 or at regular time intervals. Data of acquired information is stored in a memory 13 together with an acquisition time. Note that, in the present specification, for convenience of description, whether “side” is right or left is not distinguished, but actually, there are an external sensor that acquires information of right side region and an external sensor that acquires information of left side region.

The signal receiving unit 2 receives a signal from an outside. For example, the signal receiving unit 2 is a receiver of a global positioning system (GPS) that estimates a current position in absolute coordinates of the earth. Further, the signal receiving unit 2 may be a real time kinematic GPS (RTK-GPS) receiver that estimates the current position more accurately than the GPS. Further, the signal receiving unit 2 may be a quasi-zenith satellite system receiver. Further, the signal receiving unit 2 may be a receiver that receives a signal from a beacon fixed at a known position. Further, the signal receiving unit 2 may receive a signal from a sensor that estimates a position by relative coordinates, such as a wheel encoder, an inertial measurement unit (IMU), or a gyro. Furthermore, the signal receiving unit 2 may receive information such as a lane, a sign, a traffic condition, a shape, a size, and a height of a three-dimensional object in a travel environment. Any method may be used as long as the method can be finally used for current position estimation, control, and recognition of the autonomous driving vehicle 1 on which the in-vehicle processing device 10 is mounted.

The in-vehicle processing device 10 performs estimation of the current position of the autonomous driving vehicle 1 (self-position estimation), autonomous driving based on the current position, processing of recognizing the object around the host vehicle, cooperative autonomous driving for performing autonomous driving in cooperation with a movable object around the host vehicle, and the like. For example, the in-vehicle processing device 10 processes information acquired by the sensor 3 to calculate the position or movement amount of the autonomous driving vehicle 1. Then, the in-vehicle processing device 10 may output a signal related to the control of the autonomous driving vehicle 1. The in-vehicle processing device 10 may perform display according to the calculated position or movement amount.

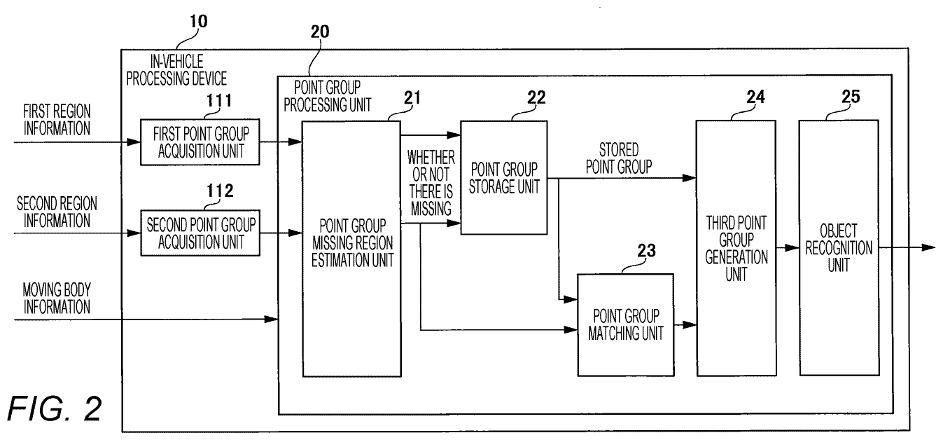

In addition, a sensor processing unit 11 processes information acquired by the external sensor of the sensor 3. For example, the sensor processing unit 11 processes the information acquired by the sensor 3 while the autonomous driving vehicle 1 is traveling to acquire the point group information, thereby detecting the object around the host vehicle. The sensor processing unit 11 corresponds to the first point group acquisition unit 111 and the second point group acquisition unit 112 illustrated in FIG. 2.

The in-vehicle processing device 10 includes, for example, a computer system (electronic computer). The in-vehicle processing device 10 includes the sensor processing unit 11, the control unit 12, the memory 13, and 2 nonvolatile storage 14. The control unit 12 is an arithmetic device such as a central processing unit (CPU). In the in-vehicle processing device 10, the control unit 12 (for example, the CPU) reads and executes a computer program stored in the memory 13 or the nonvolatile storage 14, thereby implementing functions according to the present embodiment.

Note that a part or all of the sensor processing unit 11 may be implemented by hardware using a dedicated integrated circuit or the like, or may be implemented by software. In the case of being implemented by software, the control unit 12 (for example, the CPU) reads and executes the computer program stored in the memory 13 or the nonvolatile storage 14, thereby implementing functions of the sensor processing unit 11.

The memory 13 includes a main storage device (main memory) of the in-vehicle processing device 10 and a ROM in which the computer program and the like are stored. For example, the memory 13 temporarily stores the point group data and type acquired by the sensor processing unit 11. The memory 13 also stores information that implements the functions according to the present embodiment, such as the computer program, tables, and files.

The nonvolatile storage 14 stores information and the like on an environment in which the autonomous driving vehicle 1 travels, including map information. For example, the information stored in the nonvolatile storage 14 may include, in addition to the map information, information on a shape and a position of a stationary object (tree, building, road, lane, signal, sign, road surface paint, road edge, or the like) in the travel environment. The control unit 12 accurately estimates a position of the host vehicle on the map on the basis of these pieces of information. The nonvolatile storage 14 may store the computer program and the like for implementing the functions according to the present embodiment. As the nonvolatile storage 14, a recording device such as a semiconductor memory, a hard disk, or a solid state drive (SSD), or a recording medium such as an IC card or an optical disk can be used.

The bus 4 can include an inter equipment bus (IEBUS), a local interconnect network (LIN), a controller area network (CAN), or the like.

The in-vehicle processing device 10 can wirelessly communicate with an external device 5 existing outside the autonomous driving vehicle 1 Transmission and reception between the in-vehicle processing device 10 and the external device 5 are performed by a communication IF15.

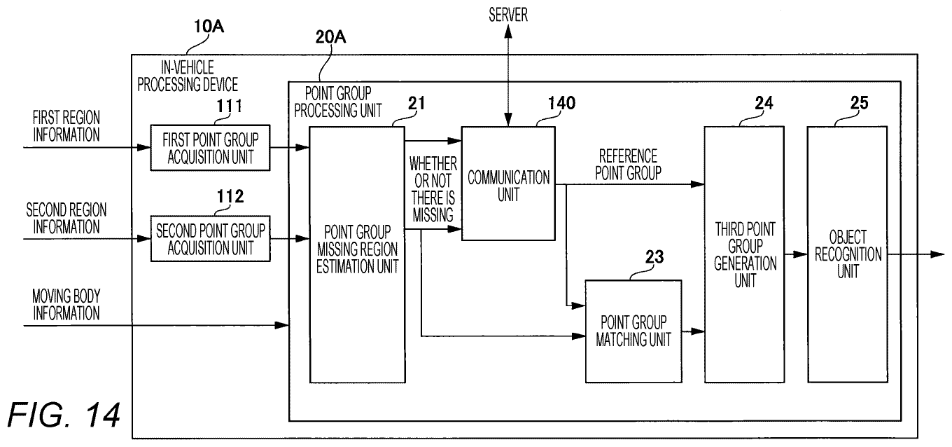

The external device 5 is a device provided outside the autonomous driving vehicle 1, and is, for example, a server (see FIG. 14) to be described later, a roadside external sensor 170 (see FIG. 17), or the like.

Note that in the in-vehicle processing device 10, the sensor processing unit 11 may process the information acquired by the sensor 3 while the autonomous driving vehicle 1 is traveling to estimate the position of the autonomous driving vehicle 1. For example, the sensor processing unit 11 calculates the movement amount of the autonomous driving vehicle 1 from the information acquired by the sensor 3 in time series, and adds the movement amount to a past position to estimate the current position. The sensor processing unit 11 may extract a feature from each piece of information acquired in time series. The sensor processing unit 11 further extracts the same feature in subsequent information. Then, the sensor processing unit 11 calculates the movement amount of the autonomous driving vehicle 1 by tracking the feature.

### [Configuration of In-vehicle Processing Device]

Next, a configuration of the in-vehicle processing device 10 will be described with reference to FIG. 2.

FIG. 2 is a diagram illustrating a configuration example of the in-vehicle processing device 10. In the present embodiment, object recognition during the cooperative autonomous driving in which the autonomous driving is performed in cooperation with the movable object around the host vehicle is assumed. During the cooperative autonomous driving, the in-vehicle processing device 10 acquires information (point group information) including a plurality of measurement points around the host vehicle using a plurality of sensors 3 (external sensors) mounted on the host vehicle, and determines whether to newly generate a point group on the basis of the acquired point group information. After the determination, the in-vehicle processing device 10 recognizes the movable object around the host vehicle using a point group acquired from the external sensor and a newly generated third point group.

The cooperative autonomous driving is a state in which the autonomous driving vehicle (host vehicle) and a target movable object move while communicating with each other, and it is necessary to constantly recognize the target movable object.

As a method for acquiring the point group information of the object using the external sensor, there is a method using the stereo camera, the laser radar, the millimeter wave radar, the ultrasonic sensor, or the like, but the method is not limited thereto.

As illustrated in FIG. 2, the in-vehicle processing device 10 includes the first point group acquisition unit 111, the second point group acquisition unit 112, and a point group processing unit 20. As described above, the in-vehicle processing device 10 is configured as, for example, a computer system including the CPU, the memory, and the like as hardware. Since the hardware executes an information processing program, functions (a point group missing region estimation unit 21, a point group storage unit 22, a point group matching unit 23, a third point group generation unit 24, and an object recognition unit 25) of the point group processing unit 20 are implemented. Note that the first point group acquisition unit 111 and the second point group acquisition unit 112 may also be implemented by hardware executing the information processing program.

Some or all of the hardware may be replaced with a dedicated processing device, a general-purpose machine learning machine, a digital signal processor (DSP), a field-programmable gate array (FPGA), a graphics processing unit (GPU), a programmable logic device (PLD), or the like.

The first point group acquisition unit 111 acquires point group information (first point group) in a specific region (first external region) around the autonomous driving vehicle 1. The second point group acquisition unit 112 acquires point group information (second point group) in a specific region (second external region) different from a region taken charge of by the first point group acquisition unit 111 in a region around the autonomous driving vehicle 1. The measurement points constituting the point group can be represented by 3D (x, y, z), 4D (x, y, z, luminance or color), or the like.

A part of a region taken charge of by the second point group acquisition unit 112 may overlap with the region taken charge of by the first point group acquisition unit 111. A density (hereinafter, point group density) of the plurality of measurement points included in the point group acquired by the second point group acquisition unit 112 is assumed to be smaller (sparser) than the point group density of the point group acquired by the first point group acquisition unit 111. That is, the second point group includes measurement points having a density smaller than the density of the measurement points of the first point group. The point group information acquired by the first point group acquisition unit 111 and the second point group acquisition unit 112 is input to the point group processing unit 20.

The in-vehicle processing device 10 may recognize the target movable object using the point group information acquired by the first point group acquisition unit 111 and the second point group acquisition unit 112. However, the point group density acquired by the second point group acquisition unit 112 is sparse in some cases, and the number of measurement points sufficient for performing the object recognition may not be secured. For example, in a case where a sufficient number of measurement points is not secured, problems occur such as the target movable object being divided into a plurality of objects and recognized, or not being recognized as the object. In a case where the target movable object is not correctly recognized, it is difficult to communicate with each other, and the cooperative autonomous driving cannot be realized.

Therefore, in the present embodiment, on the premise of using an object recognition technology utilizing the point group information, for which many known technologies already exist, the point group acquired once is stored, and in a case where a point group missing region exists in the acquired point group information, the target object is stably detected by generating dense point group information from the stored point group (stored point group) and the acquired point group.

Moving body information is information on the host vehicle acquired from the signal receiving unit 2 and the like. Examples of the moving body information include current position information of the host vehicle acquired by satellite positioning, movement amount information of the host vehicle acquired by dead reckoning, a traveling speed of the host vehicle, a measurement result of the inertial measurement unit, and an object type of the host vehicle.

The point group processing unit 20 processes the point group information acquired by the first point group acquisition unit 111 and the second point group acquisition unit 112, and recognizes the object around the host vehicle. The moving body information is also input to the point group processing unit 20. The point group processing unit 20 includes the point group missing region estimation unit 21, the point group storage unit 22, the point group matching unit 23, the third point group generation unit 24, and the object recognition unit 25.

The point group missing region estimation unit 21 discriminates whether the point group information acquired by the first point group acquisition unit 111 and the second point group acquisition unit 112 is for the movable object, and determines whether a missing region (hereinafter referred to as “point group missing region”) exists in the point group information when the point group information is for the movable object. The point group missing region is a region where the measurement points included in the point group acquired in the object around the vehicle do not satisfy a predetermined condition. Whether or not the measurement points of the acquired point group satisfy a predetermined condition for highly accurate object recognition is determined based on density of the measurement points or similarity between the acquired point group and a point group to be compared (a stored point group or a reference point group to be described later).

In the present embodiment, the point group missing region estimation unit 21 estimates the point group missing region where the density of the measurement points of the acquired point group is equal to or less than a threshold in the movable object around the vehicle, and outputs an estimation result to the point group storage unit 22 and the point group matching unit 23 as missing information. Here, the point group missing region estimation unit 21 estimates point group missing regions for both the point group acquired by the first point group acquisition unit 111 and the point group acquired by the second point group acquisition unit 112. Note that the point group missing region estimation unit 21 may be configured to output the point group information acquired by the first point group acquisition unit 111 and the second point group acquisition unit 112 to the point group storage unit 22.

Here, it is assumed that the point group missing region estimation unit 21 determines whether or not the point group missing region exists on the premise of understanding the object type of the movable object in advance. That is, the point group processing unit 20 (object recognition unit 25) determines the object type each time the point group information of a new movable object is acquired. The above-described moving body information may include information on the object type of the movable object. By grasping the object type of the movable object in advance, accuracy of determination of whether or not the point group missing region exists is improved.

The point group storage unit 22 determines whether to store the first point group acquired from the first point group acquisition unit 111 according to whether or not the missing region of the point group information determined by the point group missing region estimation unit 21 exists. However, in a case where the density of the second point group acquired by the second point group acquisition unit 112 is higher than a predetermined value, similarly to the first point group, the second point group acquired from the second point group acquisition unit 112 may be stored in the point group storage unit 22.

When the point group is stored in the point group storage unit 22, after it is determined whether the target movable object is the same in a previous cycle and a current cycle in an object recognition cycle, the stored point group is updated using the most recent (current cycle) point group for the stored point group acquired in the past (previous cycle). Note that, in a case where a movable object is newly recognized, a stored point group of the newly recognized movable object is generated.

The point group matching unit 23 performs matching between the point group acquired by the first point group acquisition unit 111 or the second point group acquisition unit 112 and the stored point group on the basis of the missing region for the point group information acquired by the point group missing region estimation unit 21. Then, the point group matching unit 23 determines which region or position (hereinafter also referred to as “matching point”) of the stored point group the acquired point group corresponds to. When the matching is performed, it is preferable to use not only three-dimensional positional information of the measurement points included in the point group but also luminance information included in the point group information. Alternatively, when color information is included in the point group information, the color information may be used.

The third point group generation unit 24 uses the stored point group of the point group storage unit 22 and information on a matching point output from the point group matching unit 23 to generate point group information denser than at least the point group information used for matching the target movable object for the matching point. At this time, instead of newly generating the point group information for the matching point, a point where the information is missing may be complemented using the stored point group based on the acquired point group in the past to generate the dense point group information. Here, a “first acquired point group” is the point group acquired by the first point group acquisition unit 111. Similarly, the point group acquired by the second point group acquisition unit 112 is referred to as a “second acquired point group”.

The object recognition unit 25 performs the object recognition on the basis of the point group (third point group) having a higher density than the point group including the missing information generated by the third point group generation unit 24. At this time, the object recognition unit 25 detects not only the object type of the target movable object but also a moving speed (an estimated speed vector) and the like, and also performs object tracking. The moving speed also includes information on a position change and an attitude change.

The attitude change is, for example, a change in a relative angle with respect to the object around the host vehicle or an absolute angle in an external world.

### [Object Recognition Processing]

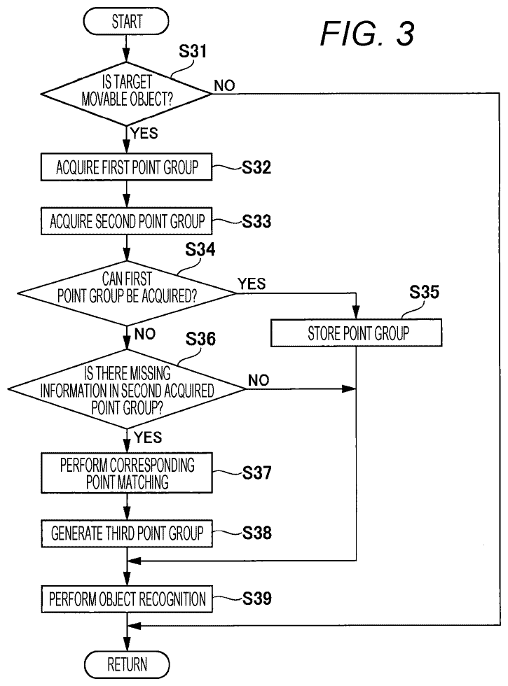

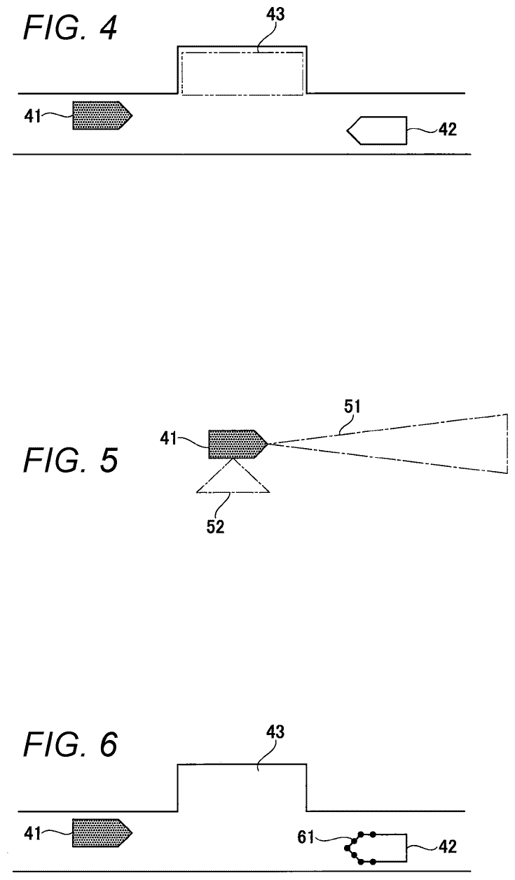

Next, an operation of the in-vehicle processing device 10 illustrated in FIG. 3 in an environment where the autonomous driving vehicle and the oncoming vehicle pass each other will be described with reference to FIGS. 4 to 11.

FIG. 3 is a flowchart illustrating a procedure example of the object recognition processing of the in-vehicle processing device 10. First, the in-vehicle processing device 10 determines whether or not the movable object exists within a sensing range on the basis of the most recent (for example, the previous cycle) output result (for example, the object type, the estimated speed vector, and the like) of the object recognition unit 25 (S31). Then, if the movable object exists (YES in S31), the process proceeds to Step S32. On the other hand, if the movable object does not exist (NO in S31), the object recognition processing ends. The movable object is an object having a moving function, and is, for example, an automobile, a motorcycle, a bicycle, a pedestrian, or the like. Therefore, the movable object includes the movable object in a stopped state.

Note that, since there is no object recognition result for an object for which the point group has been newly acquired, only the object recognition in Step S39 is performed, and it is determined from a next cycle whether a target of the object recognition in Step S31 is the movable object. Alternatively, all the detected objects may be subjected to the object recognition processing without performing determination processing in Step S31.

FIG. 4 illustrates an example of an environment in which an autonomous driving vehicle 41 and an oncoming vehicle 42 pass each other. The autonomous driving vehicle 41 corresponds to the autonomous driving vehicle 1 of FIG. 1. For example, in a case of passing each other on a narrow path as illustrated in FIG. 4, the process proceeds to Step S32 since there is the oncoming vehicle 42. Here, the narrow path is assumed to be an environment in which there is no distinction between an own lane and an opposite lane on a community road, and vehicles having different moving directions are mixed on a single line. For example, FIG. 4 illustrates an example in which the autonomous driving vehicle 41 travels in a direction from left to right, and the oncoming vehicle 42 travels in a direction from right to left. Note that a widened area 43 on the road is an evacuation path.

If the determination in Step S31 is YES, the first point group acquisition unit 111 performs first point group acquisition processing (S32), and the process proceeds to Step S33 after acquiring the first point group. Next, the second point group acquisition unit 112 performs second point group acquisition processing (S33), and proceeds to Step S34. Actually, it may be considered that the processing of Step S32 and the processing of Step S33 are performed in parallel.

FIG. 5 illustrates an example of a detectable region of the external sensor (sensor 3) mounted on the autonomous driving vehicle 41. For example, as illustrated in FIG. 5, it is assumed that information on a front region 51 is acquired by the first point group acquisition unit 111, and information on a side region 52 is acquired by the second point group acquisition unit 112. In addition, a point group acquired in the front region 51 by the first point group acquisition unit 111 is assumed to be a denser point group than a point group acquired in the side region 52 by the second point group acquisition unit 112. In general, highly accurate information can be acquired from the dense point group as compared with a sparse point group.

Next, the point group processing unit 20 determines whether or not the first point group can be acquired from the target movable object (S34). Then, if the point group processing unit 20 can acquire the first point group (YES in S34), the process proceeds to Step S35. On the other hand, if the first point group cannot be acquired (NO in S34), that is, if the target movable object does not exist in the front region 51, the process proceeds to Step S36.

FIG. 6 is a diagram illustrating an example of a sensing result of the external sensors at the time of an initial action in a passing-each-other action of the autonomous driving vehicle 41.

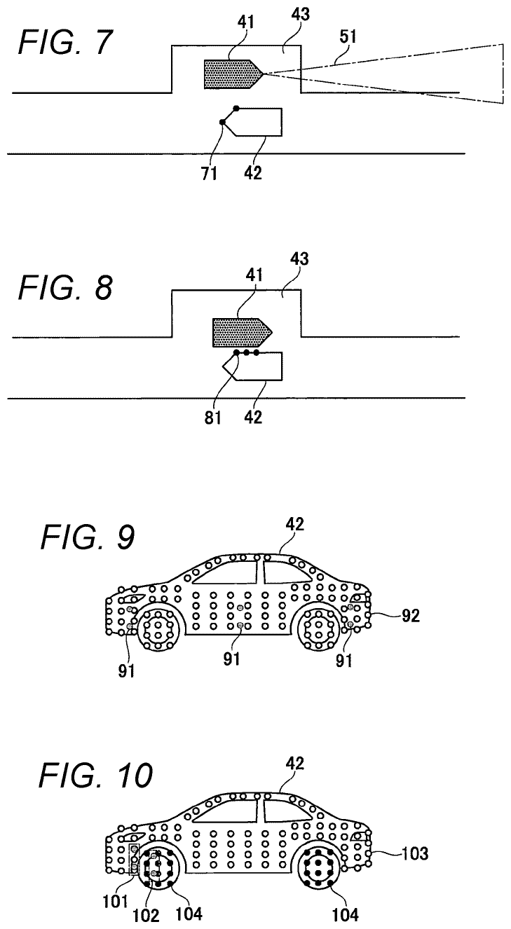

FIG. 7 is a diagram illustrating an example of the sensing result of the external sensor when the autonomous driving vehicle 41 moves to the evacuation path to perform the passing-each-other action with the oncoming vehicle 42. For example, as illustrated in FIG. 6, in a case where the oncoming vehicle 42 is in front of the autonomous driving vehicle 41, a first acquired point group 61 is acquired centered on a front surface of the oncoming vehicle 42. On the other hand, as illustrated in FIG. 7, in a case where the oncoming vehicle 42 is on the side of the autonomous driving vehicle 41, the first point group is not acquired because the oncoming vehicle 42 does not exist in the front region 51.

If it is determined YES in Step S34, the point group storage unit 22 sequentially stores the point group acquired by the first point group acquisition unit 111 (S35), and then proceeds to the object recognition in Step S39. For example, as illustrated in FIG. 6, when the external sensor detects the oncoming vehicle 42 and the first acquired point group 61 is sequentially acquired, the point group storage unit 22 stores a latest first acquired point group 61. Thus, latest point group information of the oncoming vehicle 42 is held in the point group storage unit 22 as the stored point group.

Further, instead of updating the first acquired point group 61 stored in the point group storage unit 22 with the latest point group information, the stored point group may be sequentially updated by adding a newly acquired first acquired point group 61 to the point group information acquired from the oncoming vehicle 42 in the past. At this time, when a point included in the new first acquired point group 61 already exists in the stored point group, the corresponding point is discarded rather than being added. For example, when the autonomous driving vehicle 41 and the oncoming vehicle 42 are stopped, since all the points included in the new first acquired point group 61 already exist in the stored point group, the first acquired point group 61 can be discarded.

Note that when each point of the stored point group includes not only the three-dimensional positional information but also a luminance value, also when the point included in the first acquired point group 61 already exists in the stored point group, information of the stored point group is preferably updated without discarding luminance value information of each point of the first acquired point group 61. Thus, the point group matching unit 23 performs matching processing including not only the three-dimensional positional information but also the luminance value information, thereby improving matching accuracy.

This is to prevent the point group acquired from the external sensor from being affected by ambient light, and the luminance value of the newly acquired point group from changing and being different from the luminance value of the stored point group depending on a positional relationship between the autonomous driving vehicle 41 and the oncoming vehicle 42. This improves accuracy of classifying characteristic parts (body, wheel, seat in vehicle, and the like) of the oncoming vehicle 42 based on the luminance value. In that sense, even when the autonomous driving vehicle 41 and the oncoming vehicle 42 are moving and respective points of the first acquired point group 61 and the stored point group correspond to each other, information of the new point group is preferably stored.

If it is determined NO in Step S34, the point group missing region estimation unit 21 determines whether or not there is missing information in the point group (second acquired point group) acquired by the second point group acquisition unit 112 (S36), and if there is missing information (YES in S36), the process proceeds to Step S37. If there is no missing information in the second acquired point group (NO in S36), the process proceeds to the object recognition in Step S39.

As a method for confirming that there is missing information in the second acquired point group, there is a method for making a determination based on the point group density. For example, as illustrated in FIG. 7, it is assumed that the second point group acquisition unit 112 can acquire only two points in total, that is, one point on the front surface and one point on a side surface of the oncoming vehicle 42, as a second acquired point group 71. In this case, assuming that a threshold of the point group density for determining whether or not there is missing information is 10 points per predetermined area, since the point group density of 2 points is equal to or less than the threshold, it can be determined that there is missing information. The point group density is dominated by performance of the mounted external sensor, but may also change depending on the positional relationship between the autonomous driving vehicle 41 and the oncoming vehicle 42.

FIG. 8 is a diagram illustrating an example of the sensing result of the external sensor in a case where a lateral distance between the autonomous driving vehicle and the oncoming vehicle is extremely short. For example, as illustrated in FIG. 8, when the lateral distance between the autonomous driving vehicle 41 and the oncoming vehicle 42 is extremely short, it is difficult to perform sensing in a wide range for the oncoming vehicle 42, and a second acquired point group 81 is point group information of only a specific region on the side of the oncoming vehicle 42. In such a situation, since the number of voxels including the plurality of measurement points in a predetermined space (for example, 1 m³) is reduced, it is also possible to determine that there is missing information.

Further, as another method for confirming that there is missing information, there is also a method of using the reference point group based on the type of the movable object. For example, in a case where the oncoming vehicle 42 is correctly recognized as the vehicle by the object recognition unit 25 (FIG. 2), information on the reference point group of the vehicle is extracted from a database owned by the in-vehicle processing device 10 and compared with the second acquired point group of the oncoming vehicle 42.

The reference point group is a point group including a characteristic shape representing the object type. For example, in the case of the vehicle, information necessary for representing the vehicle, such as a body, a wheel, a roof, and a door mirror, is included in the reference point group. In a case where a point group similar to the reference point group is not acquired in the second acquired point group, it is determined that there is missing information. For example, when a difference between signal levels (luminance value or the like) and positions of measurement points included in the second acquired point group and the reference point group is smaller than a predetermined value, it can be determined that a part or all of the second acquired point group is similar to the reference point group. That is, in the case of using the reference point group, the point group missing region is a region where a similarity between the measurement points included in the acquired point group and the reference point group set according to a type of the object is equal to or less than a threshold. As described above, the point group missing region estimation unit 21 may estimate a point group missing portion by comparing the measurement points of the point group of the movable object with the reference point group by the object type.

Note that since the reference point group indicates a general feature of the object type, the reference point group is used only when checking whether there is missing information in the point group. That is, it is assumed that the reference point group is not used for corresponding point matching in the point group matching unit 23 or third point group generation in the third point group generation unit 24.

After processing of Step S36, the point group matching unit 23 checks whether or not there is a point matched by the point group acquired by the second point group acquisition unit 112 in the stored point group (S37), and proceeds to Step S38. Here, the matching point is calculated using a general point group matching method such as iterative closest point (ICP) or normal distribution transform (NDT).

In the general point group matching method, a position (an initial position) of the point group recognized at a time point of the previous cycle is determined based on a distance traveled by the host vehicle. An initial position calculation method used for matching with the stored point group is changed based on a moving state of the oncoming vehicle 42. For example, in a case where the oncoming vehicle 42 stops after coming to the side of the autonomous driving vehicle 41, an initial position of the second acquired point group is determined using the movement amount from a time when update of the stored point group is stopped, that is, the movement amount from a position immediately before the point group cannot be acquired from the first point group acquisition unit 111, and a positional relationship between the first point group acquisition unit 111 and the second point group acquisition unit 112.

The positional relationship between the first point group acquisition unit 111 and the second point group acquisition unit 112 is a distance between the first point group acquisition unit 111 and the t second point group acquisition unit 112 and a relative angle between the first point group acquisition unit 111 and the second point group acquisition unit 112. As a method for calculating the movement amount of the autonomous driving vehicle 41, calculation based on the dead reckoning, a method using satellite positioning, and the like are conceivable, and the method is not limited thereto.

Further, in a case where the oncoming vehicle 42 is moving on the side of the autonomous driving vehicle 41, an initial position of the oncoming vehicle 42 is determined using the movement amount of the autonomous driving vehicle 41 and the movement amount of the oncoming vehicle 42 from the time when the update of the stored point group is stopped. A situation where the update of the stored point group (assuming that the stored point group is constituted by the first point group) stops is when the oncoming vehicle 42 stops or when the oncoming vehicle 42 is located completely on the side of the autonomous driving vehicle 41. The movement amount of the oncoming vehicle 42 can be calculated by using the estimated speed vector output by the object recognition unit 25. That is, the estimated speed vector on the point group can be calculated between the previous cycle and the current cycle, and an actual movement amount of the oncoming vehicle 42 can be calculated based on the estimated speed vector.

FIG. 9 is a diagram illustrating an example of matching between the second acquired point group and the stored point group. As illustrated in FIG. 9, the matching is difficult in a case where a second acquired point group 91 (6 points represented by intermediate gradation) of the oncoming vehicle 42 has few points or few features.

For example, in FIG. 9, it is assumed that only the second acquired point group 91 (6 points) is acquired as the point group related to the body of the oncoming vehicle 42. In this case, even if the second acquired point group 91 is moved in a front-rear direction on the side surface of the oncoming vehicle 42, there is a possibility that a plurality of candidates for a portion matching a stored point group 92 (a plurality of points represented by white circles) is detected. In a case where there is the plurality of candidates for the matching point, the initial position may be used as it is instead of using a position after relative movement of the autonomous driving vehicle 41 and the oncoming vehicle 42.

Furthermore, as the point group matching method, there is also a method of clustering points having luminance values of the point group within a predetermined range and comparing clusters, instead of matching of a single point. The point group matching unit 23 matches the stored point group with the second point group for each point group cluster in the point group missing region.

FIG. 10 is a diagram illustrating another example of the matching between the second acquired point group and the stored point group. For example, as illustrated in FIG. 10, the second acquired point group acquired from the oncoming vehicle 42 can be divided into a cluster 101 (two points represented by intermediate gradation) and a cluster 102 (two points represented by intermediate gradation). The cluster 101 is a point group acquired from the body of the oncoming vehicle 42, and the cluster 102 is a point group acquired from the wheel of the oncoming vehicle 42. By clustering the stored point group (here, the stored point group 92 in FIG. 9) as well by the luminance value, it is possible to classify the stored point group into a cluster 103 acquired from the body of the oncoming vehicle 42 and a cluster 104 acquired from the wheel of the oncoming vehicle 42. That is, in the cluster, information indicating the characteristic shape of the object (for example, a site or a component of the vehicle based on the luminance value) is associated with the point group.

By comparing the clusters between the second acquired point group and the stored point group, the cluster 101 and the cluster 103 related to the body and the cluster 102 and the cluster 104 related to the wheel are associated with each other. A matching point between the second acquired point group and the stored point group can be calculated using point groups of the clusters.

Further, the point group matching unit 23 may match the stored first point group with the second point group for each block (row of measurement points) set in a vertical direction in the point group missing region of the second point group. A change in luminance is relatively small in the vertical direction of the object, and the change in luminance is likely to occur in a horizontal direction. Therefore, the matching accuracy can be maintained at a certain level or more by the matching method.

Note that determination of whether or not there is missing information in Step S36 and the corresponding point matching in Step S37 may be combined into one processing. That is, the point group missing region estimation unit 21 may compare the second acquired point group with the stored point group to check whether there is missing information. For example, when the positional relationship with the oncoming vehicle 42 changes from a state illustrated in FIG. 6 to the state illustrated in FIG. 7, the autonomous driving vehicle 41 (host vehicle) acquires point groups from the front surface to a right side surface of the oncoming vehicle 42 in the front region 51. Therefore, the stored point group 92 as illustrated in FIG. 9 is stored for the side surface of the vehicle. Thus, it is considered that points sufficient to represent the oncoming vehicle 42 are included in the stored point group 92. The second acquired point group 91 and the stored point group 92 are matched, and it is determined that there is missing information when the point group in a specific region is insufficient. For example, in FIG. 9, since there is no point group information related to the wheel of the oncoming vehicle 42 in the second acquired point group 91, it is possible to determine that the point group information is missing.

After the processing of Step S37, the third point group generation unit 24 generates the third point group according to the matching point (point group missing region) between the second acquired point group and the stored point group (S38), and the process proceeds to Step S39. For example, as illustrated in FIG. 9, the second acquired point group 91 lacks point group information on the wheel and the roof of the oncoming vehicle 42. If the point group missing region of the second acquired point group is a region related to the wheel or the roof of the stored point group 92, the point group related to the wheel or the roof of the stored point group 92 is applied (restored) to the point group missing region of the second acquired point group 91, and generated as a dense third point group of an entire oncoming vehicle 42 acquired in the cycle.

Further, the third point group generation unit 24 may complement a space (point group missing region) between points constituting the second acquired point group using the stored point group to generate the third point group. For example, in FIG. 9, in the second acquired point group 91, the point groups are acquired only at three locations of the front (two), center (two), and rear (two) of the oncoming vehicle 42. Therefore, the dense point group is generated by complementing the point group using the stored point group 92 in a region close to the front (that is, between the front and the center) and a region close to the rear (that is, between the center and the rear) of the body of the oncoming vehicle 42. Complementation is a concept of making the second acquired point group the dense point group by filling a space between the measurement points constituting the second acquired point group with corresponding measurement points of the stored point group. Since the stored point group is used to generate the dense point group, the complementation can also be said to be a form of restoration in a broad sense.

After the processing of Step S38, the object recognition unit 25 performs the object recognition using any one of the first point group acquired by the first point group acquisition unit 111, the stored point group of the point group storage unit 22, and the third point group generated by the third point group generation unit 24 (S39), and ends the processing. There are a wide variety of object recognition methods using the point group such as rule-based and deep learning methods, but the method is not limited thereto. The object recognition unit 25 discriminates the object type by the object recognition. Further, the object recognition unit 25 also tracks the movable object by handling information of the movable object detected at each time in time series, and calculates an estimated speed (the estimated speed vector) and the like.

In a case where the first point group acquisition unit 111 can acquire the point group, the object recognition unit 25 performs the object recognition using the first acquired point group or the stored point group. At this time, when the density of the first acquired point group is not high, for example, when the oncoming vehicle 42 is located on the side in front (diagonally forward) of the autonomous driving vehicle 41, the object recognition utilizing the stored point group is performed. This enables highly accurate object recognition using the dense point group based on the point group acquired by the first point group acquisition unit 111.

Further, in a case where the first point group acquisition unit 111 cannot acquire the point group, the object recognition unit 25 performs the object recognition using the third point group generated based on the point group missing region of the second acquired point group.

The object type information, estimated speed information, and the like acquired by the object recognition are used in processing of the next cycle. Specifically, in Step S31, the object type information and the estimated speed information are used. Thus, as illustrated in FIG. 7, also when the oncoming vehicle 42 is passing on the side of the autonomous driving vehicle 41, it possible to continuously acquire a dense point group of the oncoming vehicle 42, thereby enabling stable detection of the oncoming vehicle 42 without losing sight of the oncoming vehicle 42. Then, by stably detecting the oncoming vehicle 42 until the passing-each-other ends, an event in which the autonomous driving vehicle 41 is waiting on the evacuation path for a long time and an event in which the autonomous driving vehicle 41 starts to travel toward the oncoming vehicle 42 do not occur. Therefore, safe and efficient cooperative autonomous driving is implemented in the autonomous driving vehicle 41.

Here, when the autonomous driving vehicle 41 and the oncoming vehicle 42 end the passing-each-other, the stored point group of the oncoming vehicle 42 may preferably be discarded. Thus, unnecessary point group information can be deleted from the point group storage unit 22, and storage capacity of the memory 13 of the in-vehicle processing device 10 is not excessively consumed.

For example, when the second acquired point group of the oncoming vehicle 42 cannot be acquired in the side region 52 of the autonomous driving vehicle 41, it is possible to detect that the passing-each-other with the oncoming vehicle 42 ends.

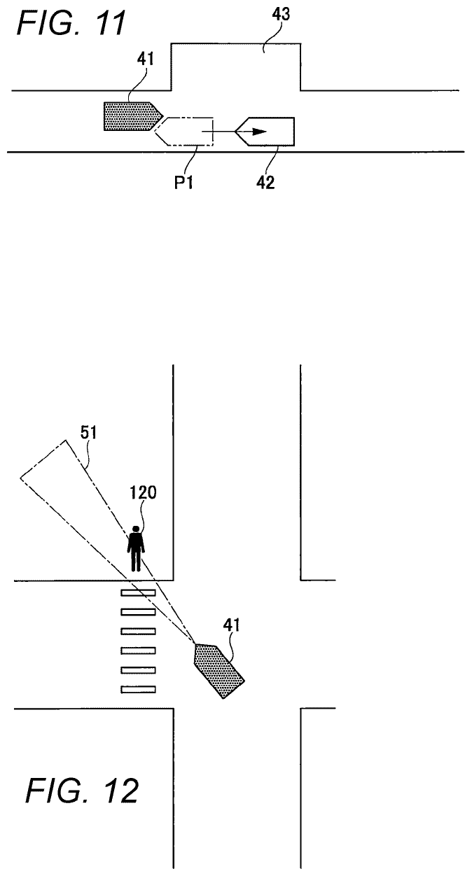

Here, a situation where the oncoming vehicle 42 approaches once and then moves backward due to a narrow road width or the like will be described with reference to FIG. 11.

FIG. 11 is a diagram illustrating an example in which the oncoming vehicle 42 moves backward. As illustrated in FIG. 11, in a case where the oncoming vehicle 42 once comes to the side (lateral vicinity Pl in FIG. 11) of the autonomous driving vehicle 41 and then moves backward, the object recognition unit 25 switches from the object recognition by the third point group utilizing the stored point group to the object recognition utilizing the first acquired point group. No matter which point group information is utilized, since the point group information is dense, the object recognition unit 25 can stably track the oncoming vehicle 42 without losing sight of the oncoming vehicle 42 also when the passing-each-other cannot be smoothly performed with the oncoming vehicle 42.

As described above, the in-vehicle processing device (in-vehicle processing device 10) according to the first embodiment includes: the first point group acquisition unit (first point group acquisition unit 111) that acquires the first point group measured in the first external region (for example, the front region 51) by the external sensors (sensors 3a to 3n) mounted on the vehicle; the second point group acquisition unit (second point group acquisition unit 112) that acquires the second point group measured in the second external region (for example, the side region 52) including a region different from the first external region by the external sensor or an external sensor different from the external sensor; and the point group processing unit (point group processing unit 20) that processes the first point group and the second point group.

The point group processing unit includes: the point group storage unit (point group storage unit 22) that stores the first point group; the point group missing region estimation unit (point group missing region estimation unit 21) that estimates the point group missing region that is the region where the measurement points included in the point group acquired in the object around the vehicle do not satisfy the predetermined condition; the point group matching unit (point group matching unit 23) that matches the stored first point group with the second point group acquired by the second point group acquisition unit, in the point group missing region; the third point group generation unit (third point group generation unit 24) that generates the third point group using the first point group and the second point group matched by the point group matching unit; and the object recognition unit (object recognition unit 25) that recognizes the object using the third point group.

By utilizing the in-vehicle processing device according to the first embodiment configured as described above, also when there is the missing region of the point group in the point group information of the object (movable object) acquired from the external sensor, the object recognition is performed by generating the dense point group (third point group) using the acquired point group and the stored point group on the basis of information of the missing region. Therefore, in the present embodiment, at least the movable object around the autonomous driving vehicle can be recognized with high accuracy. For example, discrimination of the type of the target movable object and calculation of the position and attitude of the target movable object can be performed with high accuracy.

Further, in the present embodiment, the object recognition is performed by generating the dense point group (third point group) using the acquired point group and the stored point group on the basis of the information of the missing region, thereby enabling stable object recognition. For example, in a case where the autonomous driving vehicle including the external sensor that acquires information of the front region and the external sensor that acquires information of the side region passes each other with the an oncoming vehicle, even when there is variation in the density of the measurement points of the acquired point group for each external sensor, by generating the third point group to recognize the object, it is possible to detect the oncoming vehicle stably and with high accuracy without losing sight of the oncoming vehicle. Thus, in the present embodiment, it is possible to implement the passing-each-other action which is an example of cooperative autonomous driving in the autonomous driving vehicle.

Further, in the present embodiment, since the dense point group (third point group) is generated using the acquired point group and the stored point group on the basis of the information of the missing region, it is possible to suppress an increase in amount of information on the point group of the target movable object as compared with a case where new point group information is sequentially added to past point group information.

In the in-vehicle processing device according to the present embodiment described above, the first external region is a detection region (front region 51) of the external sensor that acquires external information in front of the vehicle, and the second external region is a detection region (side region 52) of the external sensor that acquires external information on the side of the vehicle.

In general, the density of the measurement points of the acquired point group of the external sensor that acquires the external information in front of the vehicle is high, and the density of the measurement points of the acquired point group of the external sensor that acquires the external information on the side of the vehicle is lower than that of the external sensor for the front. Therefore, by setting the first external region and the second external region as described above, it is preferable when the in-vehicle processing device according to the present embodiment is applied to an actual vehicle.

### Second Embodiment

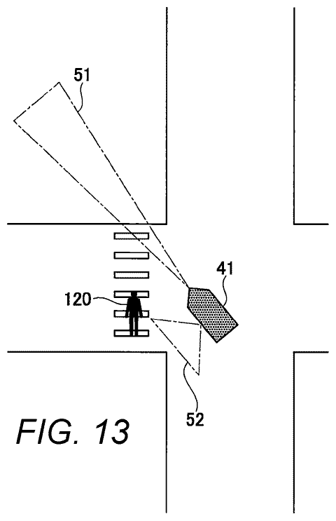

As a second embodiment, the operation of the in-vehicle processing device when the autonomous driving vehicle turns left will be described with reference to FIGS. 12 and 13. In the second embodiment, it is assumed that the autonomous driving vehicle cooperates with movement of the pedestrian to perform the autonomous driving.

FIG. 12 is a diagram illustrating an example when the autonomous driving vehicle 41 has entered an intersection in the second embodiment. FIG. 13 is a diagram illustrating an example when a pedestrian 120 is crossing the road at the intersection where the autonomous driving vehicle 41 has entered in the second embodiment. As in the first embodiment, the processing in Steps S31 to S39 illustrated in FIG. 3 is performed on an environment as illustrated in FIGS. 12 and 13.

In FIG. 12, the autonomous driving vehicle 41 attempts to turn left at the intersection. At this time, since the pedestrian 120 enters the front region 51, the in-vehicle processing device 10 determines that a recognition target is the movable object in Step S31.

Since the pedestrian 120 is in the front region 51 for several seconds after starting crossing the road (direction from a far side to a near side), the point group can be acquired by the first point group acquisition unit 111. Therefore, Step S35 is performed, and the point group of the pedestrian 120 is stored in the point group storage unit 22.

As illustrated in FIG. 12, when a left turning action of the autonomous driving vehicle 41 progresses when the pedestrian crosses the road, the pedestrian 120 is on a front right side of the autonomous driving vehicle 41. At this time, the point group acquired from the pedestrian 120 can be stored in the point group storage unit 22, but a similar operation can be expected also in a case where the pedestrian 120 is on a front left side of the autonomous driving vehicle 41.

For example, when the autonomous driving vehicle 41 is approaching the intersection, the point group of the pedestrian 120 can be stored by the pedestrian 120 existing in the front region 51. While the point group is acquired by the first point group acquisition unit 111, the pedestrian 120 can be stably detected by continuing the object recognition and the object tracking using the first acquired point group or the stored point group.

As illustrated in FIG. 13, in a case where the pedestrian 120 is about to finish crossing the road, the pedestrian 120 is not in the front region 51 and moves to the side region 52 on the left. Thus, the first point group cannot be acquired, and in Step S36, the point group missing region estimation unit 21 determines whether there is missing information in the second acquired point group. Steps S37 to S39 are performed depending on whether or not there is missing information.

Since the pedestrian 120 has a smaller surface area than the vehicle, there is a possibility that the number of measurement points acquired by the second point group acquisition unit 112 is significantly small. In consideration of this, a threshold of matching tolerance when point group matching is performed may be changed according to the type of the movable object. That is, in the case of an object having a small surface area as the type of the object, since it is considered that the number of measurement points is small and the matching accuracy is likely to vary, the threshold of the matching tolerance is set to a lower value. For example, the matching tolerance is set to 15% in the case of the vehicle, and the matching tolerance is set to 30% in the case of the pedestrian.

Further. in some cases, there is also a possibility that the point group of the pedestrian 120 is not acquired even by the second point group acquisition unit 112. In a case where the point group of the pedestrian 120 is not acquired, since the matching in Step S37 cannot be performed, the third point group is generated from the estimated speed vector output from the object recognition unit 25 and the stored point group. That is, the third point group is estimated by adding the estimated speed vector to the stored point group.

### (Vehicle Recognition When Turning Left and Right)

Although an operation example of the in-vehicle processing device 10 when the pedestrian crosses the road at the intersection has been described with reference to FIGS. 12 and 13, it is considered to be useful for preventing two-wheeled vehicles such as a motorcycle and a bicycle from being caught at the time of turning left at the intersection.

For example, when detecting the motorcycle traveling in front of the autonomous driving vehicle, the in-vehicle processing device 10 starts to store the point group acquired by the first point group acquisition unit 111. When the autonomous driving vehicle overtakes the motorcycle, the motorcycle is present on the side of the autonomous driving vehicle. At this time, it is also conceivable that there is missing information in the point group information acquired by the second point group acquisition unit 112. When there is missing information in the second acquired point group, by generating the third point group in Step S38, the stable object recognition is achieved, and unreasonable steering by the autonomous driving vehicle can be reduced. Similarly, it is possible to stably detect the oncoming vehicle when the vehicle turns right at the intersection.

### (Object Recognition When Blind Spot Region Occurs)

Further, since a plurality of vehicles travel in a mixed manner at the intersection or the like, there is a possibility that a blind spot region also occurs in the point group acquired by the first point group acquisition unit 111. Taking this into consideration, it may be determined whether there is missing information not only in the second acquired point group but also in the first acquired point group.

When there is missing information in the first acquired point group, processing similar to that when there is missing information in the second acquired point group is performed, and the third point group is generated, so that the stable object recognition can be achieved. That is, the missing information may exist in the first acquired point group from a certain time point due to overlap or the like caused by congestion, and in such a case, the third point group is created using the missing information and the stored point group (first point group) acquired so far by the corresponding external sensor.

As described above, also in a situation as described in the second embodiment, that is, also when there is the missing region of the point group in the point group information of the movable object acquired from the external sensor, similarly to the first embodiment (passing-each-other action), the object recognition can be performed by generating the dense point group (third point group) using the acquired point group and the stored point group on the basis of the information of the missing region. Therefore, also in a situation where the dense point group information cannot be acquired, it is possible to stably detect the movable object using the third point group, thereby achieving the autonomous driving ensuring safety.

### Third Embodiment

As a third embodiment, the configuration and the operation of the in-vehicle processing device in an environment where the autonomous driving vehicle merges into a main lane of a freeway will be described with reference to FIGS. 14 to 17. Note that in the present embodiment, merging into the main line of the freeway is taken as an example, but the same applies to lane change on the main lane of the freeway and a general road. For example, the lane change may be a change from a driving lane to an overtaking lane, or vice versa.

### [Configuration of In-vehicle Processing Device]

FIG. 14 is a diagram illustrating a configuration example of an in-vehicle processing device 10A according to the third embodiment. The in-vehicle processing device 10A is different from the in-vehicle processing device 10 (FIG. 2) according to the first embodiment in that a point group processing unit 20A of the in-vehicle processing device 10A includes a communication unit 140 instead of the point group storage unit 22. The communication unit 140 is provided between the point group missing region estimation unit 21 and the third point group generation unit 24 and between the point group missing region estimation unit 21 and the point group matching unit 23.

In the in-vehicle processing device 10A, since the hardware of the computer system executes the information processing program, functions (point group missing region estimation unit 21, communication unit 140, point group matching unit 23, third point group generation unit 24, and the object recognition unit 25) of the point group processing unit 20A are implemented.

The communication unit 140 wirelessly communicates with the server that is an example of the external device 5 (FIG. 1), acquires the reference point group according to the object type from the server, and outputs the reference point group to the point group matching unit 23 and the third point group generation unit 24.

### [Object Recognition Processing]

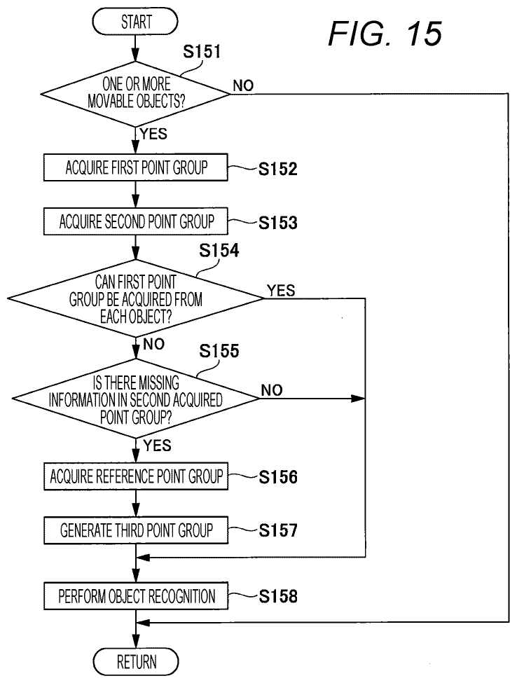

FIG. 15 is a flowchart illustrating a procedure example of the object recognition processing of the in-vehicle processing device 10A.

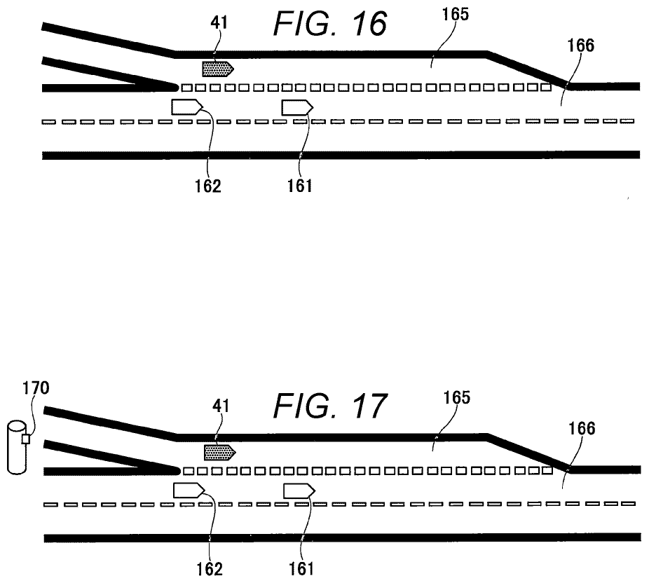

FIG. 16 is a diagram illustrating an example of an environment in which the autonomous driving vehicle 41 merges in cooperation with a plurality of surrounding vehicles traveling on a main lane 166 of the freeway.

For example, in a case of merging onto the freeway as illustrated in FIG. 16, the autonomous driving vehicle 41 changes lanes from an acceleration lane 165 to the main lane 166 so as to enter between the following vehicle 162 and the preceding vehicle 161. In the first embodiment and the second embodiment, there is one target movable object, but in the case of merging, there is a case where the autonomous driving vehicle must act in cooperation with two or more movable objects.

First, the in-vehicle processing device 10A determines whether or not the movable object exists within the sensing range of the autonomous driving vehicle 41 on the basis of the most recent (for example, the previous cycle) output result (for example, the object type, the estimated speed vector, and the like) of the object recognition unit 25 (S151). Here, it is determined whether or not the object is the movable object for all objects around the autonomous driving vehicle 41. Then, if one or more movable objects exist (YES in S151), the process proceeds to Step S152. On the other hand, if the movable object does not exist around the host vehicle (NO in S151), the object recognition processing ends.

If it is determined YES in Step S151, the first point group acquisition unit 111 performs the first point group acquisition processing (S152), and the process proceeds to step S153. Next, the second point group acquisition unit 112 performs the second point group acquisition processing (S153), and proceeds to Step S154. Actually, it may be considered that the processing of Step S152 and the processing of Step S153 are performed in parallel.

Next, the point group processing unit 20A determines whether or not the first point group can be acquired from each movable object (the following vehicle 162 and the preceding vehicle 161 in FIG. 16) (S154). That is, the point group processing unit 20A determines whether the first acquired point group exists for each movable object. Then, if the point group processing unit 20A can acquire the first point group from each movable object (YES in S154), the process proceeds to Step S158. On the other hand, if the first point group cannot be acquired from each movable object (NO in S154), that is, if each movable object does not exist in the front region 51, the process proceeds to Step S155. Here, if there is even one movable object for which the first point group cannot be acquired, the process proceeds to Step S155.

For example, in an example illustrated in FIG. 16, the following vehicle 162 travelling in parallel with the autonomous driving vehicle 41 is a target of the second acquired point group, and the preceding vehicle 161 is a target of the first acquired point group. When the merging is performed in a situation where the following vehicle 162 exists on the main lane 166, it is difficult to acquire a dense point group of the following vehicle 162 located on the side of the autonomous driving vehicle 41, and it is also difficult to create the stored point group.

If it is determined NO in Step S154, the point group missing region estimation unit 21 determines whether or not there is missing information in the point group (second acquired point group) acquired by the second point group acquisition unit 112 (S155), and if there is missing information in the second acquired point group (YES in S155), the process proceeds to Step S156. If there is no missing information in the second acquired point group (NO in S155), the process proceeds to the object recognition in Step S158. As in the first embodiment, whether or not there is missing information can be determined from the point group density of the second acquired point group. Alternatively, whether or not there is missing information may be determined using the reference point group for checking the missing information.

If it is determined YES in Step S155, the communication unit 140 communicates with an external server to acquire the reference point group of the movable object corresponding to the second acquired point group including missing information (S156). For example, in a case illustrated in FIG. 16, since it is merging into the main lane 166 of the freeway, it can be seen that the movable object is any one of a general vehicle, a truck, a bus, and a motorcycle. Therefore, reference point groups of the general vehicle, the truck, the bus, and the motorcycle are acquired from the server.

Note that a processing order of Steps S155 and S156 may be reversed in order to determine whether there is missing information in the second acquired point group. The communication unit 140 acquires the reference point group in advance and compares the reference point group with the second acquired point group, so that it is possible to determine whether there is missing information. At this time, since the object type of the target movable object has not been determined, comparison is performed with the reference point groups of all movable object candidates. In the case illustrated in FIG. 16, the point group missing region estimation unit 21 compares the second acquired point group with all the reference point groups of the general vehicle, the truck, the bus, and the motorcycle, to check whether there is missing information.

Then, the point group matching unit 23 checks whether or not there is a point matched by the point group acquired by the second point group acquisition unit 112 in the reference point group. This matching processing is similar to the processing in Step S3 in FIG. 3. Further, the same applies to a case where the point group missing region estimation unit 21 determines whether or not there is missing information using the reference point group.

The point group matching unit 23 or the point group missing region estimation unit 21 may calculate a likely object type candidate of the movable object in each cycle by using a matching degree when the second acquired point group is compared with the reference point group of each movable object. When likely object type candidates are the same in a plurality of cycles, the object type candidate is determined as an object type of an actual movable object.

Next, the third point group generation unit 24 generates the third point group according to the matching point (point group missing region) between the second acquired point group and the reference point group (S157), and the process proceeds to Step S158. In a case where there is a plurality of object type candidates of the movable object, the third point group is generated using a feature common to the reference point groups of the movable object candidates. For example, when it is known that the movable object is any of the general vehicle, the truck, the bus, and the motorcycle, since the wheel and the body are common to all the object type candidates, point groups corresponding to the wheel and the body are added to the second acquired point group.

Next, using the first point group acquired by the first point group acquisition unit 111 or the third point group generated by the third point group generation unit 24, the object recognition unit 25 performs the object recognition and the object tracking on all the objects around the autonomous driving vehicle 41 (S158), and ends the processing. The object recognition unit 25 performs the object recognition on all the movable objects existing within the sensing range. For example, in the case illustrated in FIG. 16, the object recognition using the third point group is performed on the following vehicle 162, and the object recognition using the first acquired point group is performed on the preceding vehicle 161.

### [Modification of Third Embodiment]

Here, a modification of the third embodiment will be described with reference to FIG. 17.

FIG. 17 is a diagram illustrating an example of an operation in which the autonomous driving vehicle 41 communicates with a roadside external sensor and stores a dense point group of the surrounding vehicles traveling on the main lane 166 in the third embodiment.

FIG. 17 illustrates an example in which the point group information of the roadside external sensor 170 installed near a merging portion (in front of the merging portion) is acquired via the communication unit 140 of the in-vehicle processing device 10A mounted on the autonomous driving vehicle 41. The communication unit 140 wirelessly communicates with the roadside external sensor 170. Here, the density of the measurement points of the point group acquired by the roadside external sensor 170 is equivalent to the density of the measurement points of the first acquired point group. That is, by using the roadside external sensor 170, it is possible to acquire high density point group information on an entire vehicle (at least a region including the side surface and a rear surface) of the vehicle traveling on the main lane 166 or the side of the vehicle.

Since the point group density of the roadside external sensor 170 is high, it is possible to check whether or not there is missing information in the second acquired point group by comparing the second acquired point group with the point group information of the roadside external sensor 170 in Step S155 in an environment illustrated in FIG. 17. Further, in Step S157, the third point group is generated by using the second acquired point group and the point group information of the roadside external sensor 170. Furthermore, in Step S158, since the point group information of the roadside external sensor 170 exists, the object type of the movable object can be recognized with high accuracy.

As described above, also in a situation as described in the third embodiment, that is, also when there is the missing region of the point group in the point group information of the movable object acquired from the external sensor, similarly to the first embodiment (passing-each-other action), the object recognition can be performed by generating the dense point group (third point group) using the acquired point group and the reference point group on the basis of the information of the missing region. The in-vehicle processing device 10 A according to the present embodiment can stably recognize the target movable object by acquiring the point group information (reference point group) of the target movable object from the outside via the communication unit 140. Thus, in the present embodiment, it is possible to implement the merging which is an example of cooperative autonomous driving in the autonomous driving vehicle.

Note that the present invention is not limited to the above-described embodiments, and it is obvious that various other application examples and modifications can be taken without departing from the gist of the present invention described in the claims. For example, the above-described embodiments describe the configuration of the present invention in detail and specifically in order to describe the present invention in an easy-to-understand manner, and are not necessarily limited to those including all the described components. Further, a part of configuration of one embodiment can be replaced with a component of another embodiment. Further, a component of another embodiment can be added to the configuration of one embodiment. Furthermore, it is also possible to add, replace, or delete another component for a part of the configuration of each embodiment.

Further, in the present specification, processing steps describing time-series processing include not only processing performed in time series according to a described order, but also processing (for example, processing by an object) performed in parallel or individually even if the processing is not necessarily performed in time series. Furthermore, the processing order of the processing steps describing the time-series processing may be changed within a range not affecting the processing result.

Further, in the above-described embodiment, control lines and information lines considered to be necessary for description are illustrated, and not all control lines and information lines are necessarily illustrated in terms of products. In practice, it may be considered that almost all the components are connected to each other.

### REFERENCE SIGNS LIST

1 autonomous driving vehicle
3a to 3n sensor
10, 10A in-vehicle processing device
11 sensor processing unit
20, 20A point group processing unit
21 point group missing region estimation unit
22 point group storage unit
23 point group matching unit
24 third point group generation unit
25 object recognition unit
41 autonomous driving vehicle
42 oncoming vehicle
51 front region
52 side region
92 stored point group
111 first point group acquisition unit
112 second point group acquisition unit

1. An in-vehicle processing device comprising:
a first point group acquisition unit that acquires a first point group measured, in a first external region, by an external sensor mounted on a vehicle;
a second point group acquisition unit that acquires a second point group measured, in a second external region including a region different from the first external region, by the external sensor or an external sensor different from the external sensor; and
a point group processing unit that processes the first point group and the second point group,
wherein the point group processing unit includes
a point group storage unit that stores the first point group,
a point group missing region estimation unit that estimates a point group missing region that is a region where measurement points included in a point group acquired in an object around the vehicle do not satisfy a predetermined condition,
a point group matching unit that matches the stored first point group with the second point group acquired by the second point group acquisition unit, in the point group missing region,
a third point group generation unit that generates a third point group using the first point group and the second point group matched by the point group matching unit, and
an object recognition unit that recognizes the object using the third point group.

2. The in-vehicle processing device according to claim 1, wherein the point group missing region is a region where a density of the measurement points included in the acquired point group is equal to or less than a threshold.

3. The in-vehicle processing device according to claim 2, wherein
the point group missing region estimation unit estimates a point group missing region where a density of measurement points in a point group is equal to or less than a threshold in a movable object that is an object movable around the vehicle, and
the object recognition unit recognizes the movable object using the third point group.

4. The in-vehicle processing device according to claim 1, wherein the third point group generation unit generates the third point group by applying the stored first point group to the point group missing region of the second point group.

5. The in-vehicle processing device according to claim 1, wherein the third point group generation unit complements a space between the measurement points in the point group missing region of the second point group using the stored first point group to generate the third point group.

6. The in-vehicle processing device according to claim 1, wherein the second point group includes measurement points having a density smaller than a density of measurement points of the first point group.

7. The in-vehicle processing device according to claim 6, wherein
the first external region is a detection region of an external sensor that acquires external information in front of the vehicle, and
the second external region is a detection region of an external sensor that acquires external information on a side of the vehicle.

8. The in-vehicle processing device according to claim 1, wherein the point group missing region is a region where a similarity between the measurement points included in the acquired point group and a reference point group set according to a type of the object is equal to or less than a threshold.

9. An object recognition method in an in-vehicle processing device including: a first point group acquisition unit that acquires a first point group measured in a first external region by an external sensor mounted on a vehicle;
a second point group acquisition unit that acquires a second point group measured in a second external region including a region different from the first external region by the external sensor or an external sensor different from the external sensor; and a point group processing unit that processes the first point group and the second point group, the object recognition method comprising causing the point group processing unit to perform:
processing of storing the first point group;
processing of estimating a point group missing region that is a region where measurement points included in a point group acquired in an object around the vehicle do not satisfy a predetermined condition;
processing of matching the stored first point group and the second point group acquired by the second point group acquisition unit, in the point group missing region;
processing of generating a third point group using the first point group and the second point group matched; and
processing of recognizing the object using the third point group.
